(19) United States
(12) Patent Application Publication
(10) Pub. No.: US 2008/0059693 A1
(43) Pub. Date: Mar. 6, 2008

(54) METHOD FOR IMPROVING LIFESPAN OF FLASH MEMORY

(75) Inventors: Cheng-chih Yang, Taipei City (TW); Fong-hsu Wei, Shenkeng Township (TW); Che-wei Chang, Chiayi City (TW)

Correspondence Address: MADSON & AUSTIN, 15 WEST SOUTH TEMPLE, SUITE 900, SALT LAKE CITY, UT, 84101, US

(73) Assignee: Genesys Logic, Inc., Shindian City (TW)

(21) Appl. No.: 11/844,355

(22) Filed: Aug. 24, 2007

(30) Foreign Application Priority Data
Sep. 5, 2006 (TW) 095132660

(51) Int. Cl. G06F 12/06

(52) U.S. Cl. 711/103; 711/E12.008

(57) ABSTRACT

A method for improving the lifespan of flash memory is provided. By defining and configuring a plurality of memory block counters, the method assigns a counter to each memory block to record the number of writes to the memory block. With configuring a threshold for the counter, the counter is compared to the threshold for each write to the memory block so as to determine the priority update, data erase, update and move. The counter is also synchronously erased, updated, and moved so that the number of the writes to the flash memory blocks can be controlled by the configuration. Hence, the object of prolonging lifespan and reliability of the flash memory access is achieved.

### BACKGROUND OF THE INVENTION

1. Field of the Invention

The present invention relates to a method for improving the lifespan of flash memory and, more particularly, to a method for improving the flash memory lifespan with the use of a configurable counter for the flash memory block access.

2. The Related Arts

Flash memory is widely used in many digital types of equipment, such as flash drives and MP3 players. The conventional flash memory uses a data access control circuit to control the data access to the flash memory. FIG. 1 of the attached drawings shows a conventional data access control circuit for flash memory. As shown in FIG. 1, the control circuit A includes a flash memory control interface A1, a RAM A2, a microprocessor A3, a DMA unit A4, and an upstream interface A5. The flash memory control interface A1 is connected to a flash memory B to control data access to the flash memory B. The RAM A2 is connected to the flash memory control interface A1 to provide the temporary storage of the data and the instruction for data access to the flash memory B. Te microprocessor A3 controls the data access to the flash memory B. The DMA unit A4 provides the direct access control for flash memory B, and the upstream interface A5 provides the flash memory B with connections to a PC, a notebook, and other electronic devices to allow the electronic devices to access data in the flash memory B.

The conventional control process of flash memory requires the configuration of the memory blocks so that the flash memory uses the memory blocks as unit for data access when the control circuit A issues a data access instruction. However, this type of data access control process has the following drawbacks. First, the utilization of each individual memory block is not uniform among the blocks; that is, some blocks are used much more often than the other blocks, while some blocks are rarely used or accessed. In addition, the frequently accessed memory blocks may suffer the problem referred to as wearing-off and lead to damages and the loss of data. This reduces the lifespan of the flash memory. Various techniques, called wear-leveling techniques, have been proposed to address the issue.

U.S. Pat. No. 6,985,992 disclosed a technique in wear-leveling in non-volatile storage system, including the use of redundant area as the counter of writing flash memory block. However, this technique reduces the memory block writing efficiency when repetitively erasing the counters in the redundant area.

U.S. Patent Publication No. 2005/0055495 disclosed a method of memory wear-leveling, including the use of hot spot to configure the number of writes to the memory blocks. This method is not effective when the memory blocks are frequently re-assigned when the data are frequently accessed. Therefore, this method does not achieve the object of uniform utilization of the flash memory blocks.

### SUMMARY OF THE INVENTION

An object of the present invention is to provide a method for improving the lifespan of flash memory, including the one-to-one counter for each memory block so that the number of writes to the memory blocks can be accurately recorded and the utilization of memory blocks is improved.

Another object of the present invention is to provide a method for improving the lifespan of flash memory, including the use of a threshold for each counter, and the erase, update and move operation on the memory blocks being configured according to the threshold as to improve the lifespan of the flash memory.

Yet another object of the present invention is to provide a method for improving the lifespan of flash memory, including the synchronized erase, update and move of the counter value with the erase, update and move of the memory blocks, so that the memory blocks, both frequently or rarely used, can be accurately assigned and uniformly used.

To achieve the above objects, the present invention provides a method for improving the lifespan of flash memory. By defining and configuring a plurality of memory block counters, the method of the present invention assigns a counter to each memory block to record the number of writes to the memory block. With configuring a threshold for the counter, the counter is compared to the threshold for each write to the memory block so as to determine the priority update, data erase, update and move. The counter writes to the flash memory blocks can be controlled by the configuration. Hence, the object of prolonging lifespan and reliability of the flash memory access is achieved.

These and other objects, features, and advantages of the invention will be apparent to those skilled in the art, from a reading of the following brief description of the drawings, the detailed description of the preferred embodiment, and the appended claims.

### BRIEF DESCRIPTION OF THE DRAWINGS

The present invention can be understood in more detail by reading the subsequent detailed description in conjunction with the examples and references made to the accompanying drawings, wherein:

FIG. 1 shows a block diagram of a conventional control circuit of a flash memory;

FIG. 2 shows a schematic view of the configuration of flash memory blocks used in a method in accordance with the present invention;

FIG. 3(a) shows the correspondence relation between the physical memory blocks and the logical memory blocks and the logical memory free blocks of the present invention;

FIG. 3(b) shows the correspondence relation of the elements defined in the method of the present invention;

FIG. 4 shows a flowchart of the method for improving lifespan of flash memory of the present invention;

FIG. 5 shows a view before data writing in an application according to the method of the present invention; and

FIG. 6 shows a view after data writing in an application of FIG. 5 according to the method of the present invention.

### DETAILED DESCRIPTION OF THE BEST MODE FOR CARRYING OUT THE INVENTION

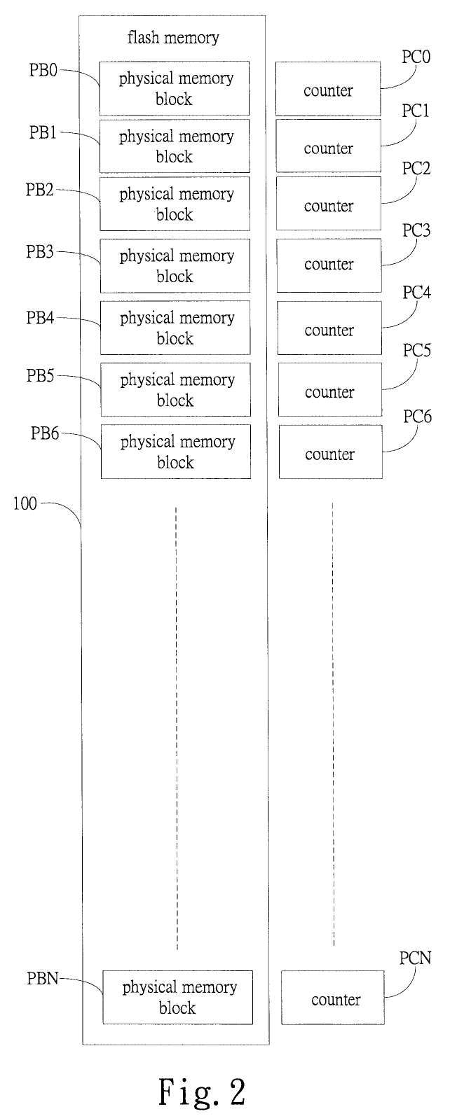

FIG. 2 shows a method for improving lifespan of a flash memory in accordance with the present invention. First, a plurality of counters PC0-PCN are defined and configured for a plurality of physical memory blocks PB0-PBN of a flash memory 100. The physical memory blocks PB0-PBN and the counters PC0-PCN have a one-to-one-correspondence relation. The counters PC0-PCN can be a part of the flash memory 100 configured during the formatting, or the counter array formed by memory address of the flash memory 100. The counters PC0-PCN are to record the number of writes to the physical memory blocks PB0-PBN. The counters PC0-PCN are programmable, and can be configured with a threshold.

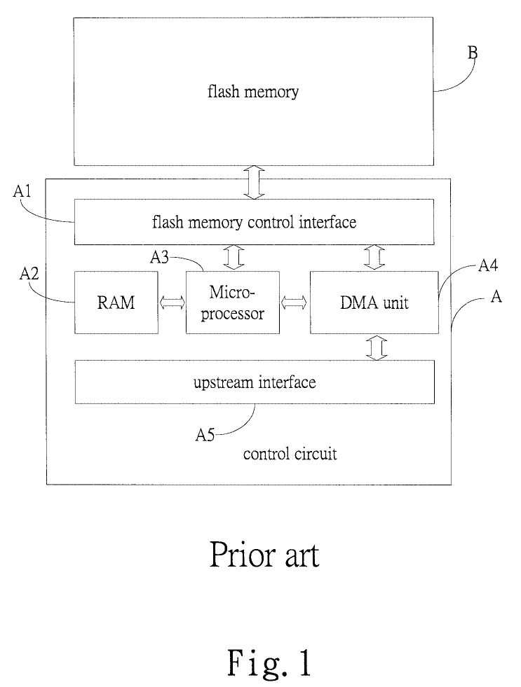

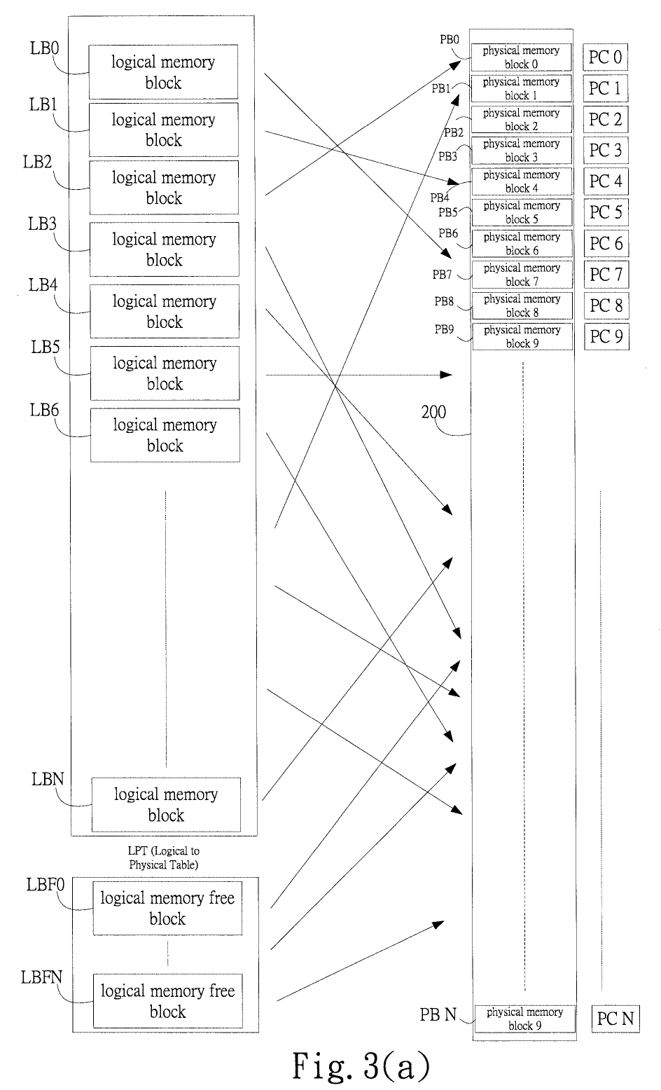

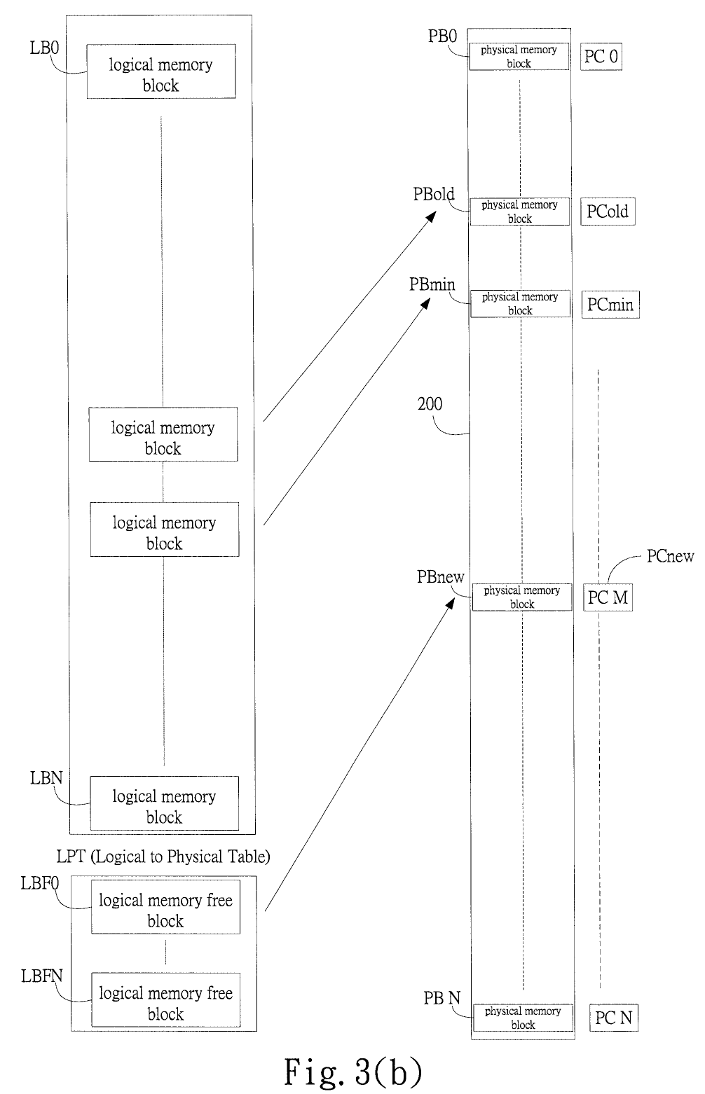

FIG. 3(a) shows a correspondence relation between the physical memory blocks, the logical memory blocks and the logical memory free blocks of the flash memory of the present invention. As shown in FIG. 3(a), a plurality of logical memory blocks LB0-LBN and a plurality of logical memory free blocks LBF0-LBFN are defined and configured in the flash memory 100 for the physical memory blocks PB0-PBN. The definition and the configuration of the logical memory blocks and logical memory free blocks can be included as a program or software in the microprocessor A3 of the control circuit A of FIG. 1. A logical to physical table (LPT) can be used to obtain the correspondence relation between the physical memory blocks PB0-PBN and the logical memory blocks LB0-LBN and the logical memory free blocks LBF0-LBFN, as shown in FIG. 3(a). Therefore, when the control circuit A of FIG. 1 issues a write instruction to the flash memory 100, the destination physical memory block PB0-PBN can be found.

FIG. 3(b) shows further definition of the memory block among the physical blocks PB0-PBN with the minimum counter value as PBmin. The number of PBmin can be more than one. The old memory block is PBold, and the new memory free block is PBnew. The counter with minimum value is PCmin, also between PC0-PCN. The counter corresponds to PBnew is counter PCnew.

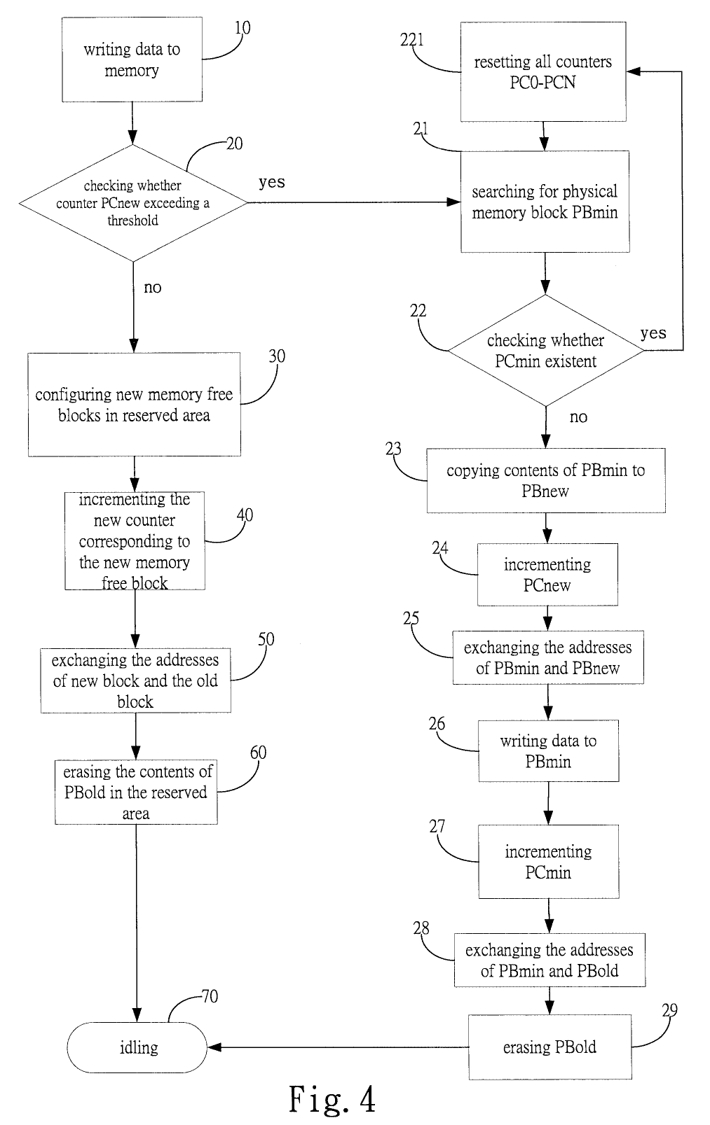

FIG. 4 shows a flowchart of a data writing method in accordance with the present invention, comprising the following steps of:

(10) writing data to memory, including the flash memory B of FIG. 1 controlled by the control circuit A to write data into a logical memory block, the logical memory block corresponding to physical memory block PBold, and the microprocessor A3 finding a new free memory block PBnew to write the data and replace PBold;

(20) checking whether counter PCnew exceeding a threshold; if so, proceed to step (21); otherwise, proceed to step (30);

(21) searching for physical memory block PBmin, including searching for the minimum counter PCmin among counter PC0-PCN, and finding corresponding physical memory block PBmin;

(22) checking whether PCmin existent; if so, proceed to step (221); otherwise, proceed to step (23);

(221) resetting all counters PC0-PCN, and returning to step (21);

(23) copying contents of PBmin to PBnew, including copying the content of PBmin found in step (22) to PBnew;

(24) incrementing PCnew, including incrementing PCnew corresponding to PBnew of step (23);

(25) exchanging the addresses of PBmin and PBnew, including exchanging the physical addresses of PBmin and PBnew of step (23) to map to each other's logical memory block, and erasing the data in PBmin;

(26) writing data to PBmin;

(27) incrementing PCmin, including incrementing PCmin corresponding to PBmin of step (26);

(28) exchanging the addresses of PBmin and PBold, including exchanging the physical addresses of PBmin of step (26) and PBold to map to each other's logical memory block;

(29) erasing PBold, including erasing the contents of the exchanged PBold of step (28) and PBold becoming PBnew, then proceed to step (70);

(30) configuring new memory free blocks in reserved area, including configuring a new memory free block PBnew in the reserved area of the flash memory 100;

(40) incrementing the new counter corresponding to the new memory free block, including incrementing PCnew corresponding to PBnew of step (30);

(50) exchanging the addresses of new block and the old block, including exchanging the addresses of PBnew of step (30) and PBold;

(60) erasing the contents of PBold in the reserved area, including erasing the contents of the exchanged PBold of step (50) in the reserved area; and

(70) idling, and waiting for the next write instruction.

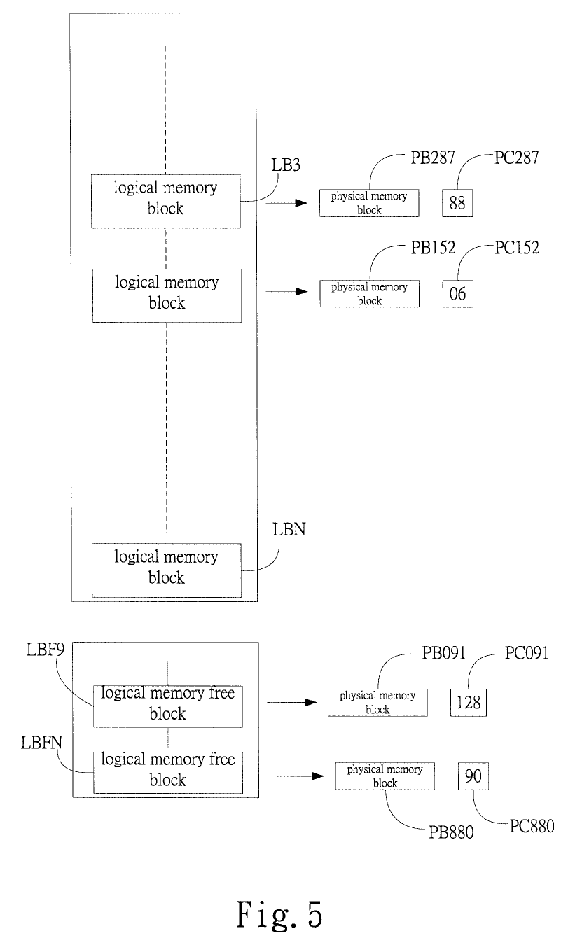

FIG. 5 shows the actual application of the present invention, where the flash memory 100 receives data written to LB3 from the control circuit A of FIG. 1, and searches for memory block PB091 corresponding to the logical memory free block. The counter PC091 of the memory block PB091 is 128, and the configured threshold of the counters PC0-PCN is 128. PBmin is PB152, with PC152=6. Because the corresponding logical memory free block is LBF9, the PBnew is PB091 with PCnew=128. FIG. 5 shows the situation before the data is written.

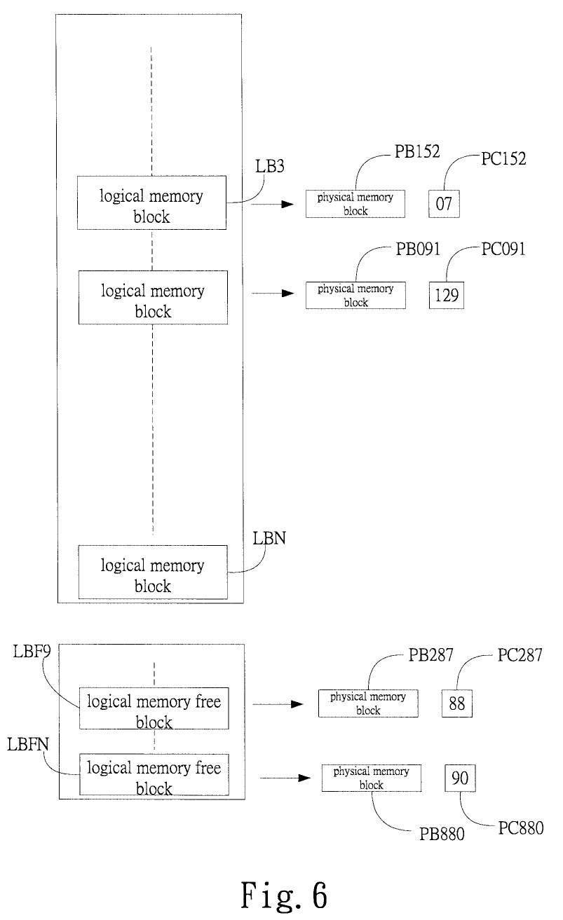

FIG. 6 shows the view after the data is written. As in step (23), PB152 is copied to PB091, and as in step (24), PC091 is increment to 129. As in step (25), the addresses of PB091 and PB152 are exchanged, and PB152 is erased. As in step (26), data is written to PB152, and as in step (27), the addresses of PB091 and PB287 are exchanged so that PB091 corresponds to LB3. As in step (29), PB287 is erased, and the result is shown in FIG. 6.

The operation of method of the present invention shown in FIG. 4-6 can be stored as software or a program in the microprocessor A3 of the control circuit A of FIG. 1 to provide the later application.

While the invention has been described in connection with what is presently considered to the most practical and preferred embodiment, it is to be understood that the invention is not to be limited to the disclosed embodiment, but on the contrary, is intended to cover various modifications and equivalent arrangement included within the spirit and scope of the appended claims.

What is claimed is:

1. A method for improving lifespan of a flash memory, comprising the following steps:
(a) writing data to memory, a flash memory being controlled by a control circuit to write data into an old memory block, the flash memory being configured into a plurality of physical memory blocks and a plurality of counters, the physical memory blocks corresponding one-to-one to the counter, the counter recording the number of writes to the physical memory blocks, the counters having a threshold, the physical memory blocks corresponding to a plurality of logical memory blocks and a plurality of logical memory free blocks, respectively;
(b) checking whether counter exceeding a threshold, checking whether counter of step (a) exceeding the threshold, if so, proceed to step (b1), otherwise, proceed to step (c);
(b1) searching for physical memory block with minimum counter, searching for the minimum counter among all the counters of step (a), and finding corresponding physical memory block;
(b2) checking whether the minimum counter existent; if so, proceed to step (b21), otherwise, proceed to step (b3);
(b21) resetting all the counters of step (a), and returning to step (b1);
(b3) copying contents of the physical memory block with minimum counter to new memory block, copying the content of the physical memory block with minimum counter found in step (b2) to new memory block of step (a);
(b4) incrementing the new counter, incrementing the new counter corresponding to the new memory block of step (b3);
(b5) exchanging the addresses of the physical memory block with minimum counter and the new memory block, exchanging the physical addresses of the physical memory block with minimum counter and the new memory block of step (b3) to map to each other's logical memory block;
(b6) writing data to the physical memory block with minimum counter, writing the data of step (a) to the physical memory block with minimum counter of step (b5);
(b7) incrementing the minimum counter, including incrementing the minimum counter corresponding to the physical memory block with minimum counter of step (b6);
(b8) exchanging the addresses of the physical memory block with minimum counter and the old memory block, including exchanging the physical addresses of the physical memory block with minimum counter of step (b6) and the old memory block to map to each other's logical memory block;
(b9) erasing the old memory block, including erasing the contents of the exchanged the old memory block of step (b8) and the old memory block becoming the new memory block, then proceed to step (g);
(c) configuring new memory free blocks in a reserved area, including configuring a new memory free block in the reserved area of the flash memory;
(d) incrementing the new counter corresponding to the new memory free block of step (c);
(e) exchanging the addresses of the new memory block of step (c) and the old memory block;
(f) erasing the contents of the physical memory block with minimum counter exchanged in step (e) in the reserved area; and
(g) idling, and waiting for the next write instruction.

2. The method as claimed in claim 1, wherein the counters in step (a) are a counter array configured in the flash memory.

3. The method as claimed in claim 1, wherein the physical memory blocks of step (a) correspond to a plurality of logical memory blocks and a logical memory free blocks.

4. The method as claimed in claim 1, wherein the address of the memory block with the minimum counter in step (b8) corresponds to the logical memory block to be written to in the flash memory
